(19) United States
(12) Patent Application Publication
(10) Pub. No.: US 2017/0187091 A1
(43) Pub. Date: Jun. 29, 2017

(54) APPLIANCE INCLUDING AN ANTENNA USING A PORTION OF APPLIANCE AS A GROUND PLANE

(71) Applicant: WHIRLPOOL CORPORATION, Benton Harbor, MI (US)

(72) Inventors: Rachael Acker, East Lansing, MI (US); Zachary J. Bruin-Slot, Baroda, MI (US); Wyndham F. Gary, JR., Whitefish Bay, WI (US); David W. Mundy, St. Joseph, MI (US)

(73) Assignee: WHIRLPOOL CORPORATION, Benton Harbor, MI (US)

(21) Appl. No.: 14/982,137

(22) Filed: Dec. 29, 2015

(51) Int. Cl. H01Q 1/22; H01Q 1/38

(52) U.S. Cl. CPC H01Q 1/22; H01Q 1/38

(57) ABSTRACT

An appliance, such as an oven, includes a housing having an internal compartment and an RF antenna. At least a portion of the housing comprises an electrically conductive portion. The antenna includes an active component and a connection to the electrically conductive portion, which serves as a ground plane of the antenna. The housing may include a door assembly having a window that includes the electrically conductive portion in the form of a transparent conductive layer. The door assembly may be detachable and the connection to the antenna may be made by way of capacitive coupling. In an alternative arrangement, the housing includes a light fixture for illuminating the internal compartment, wherein the active component of the antenna is disposed in the light fixture.

### BACKGROUND

The present device generally relates to household appliances, and more specifically, to an oven appliance.

### SUMMARY

In at least one aspect, an appliance is provided that comprises a housing including an internal compartment, wherein at least a portion of the housing comprises an electrically conductive portion, and an antenna for at least one of receiving RF signals and transmitting RF signals, wherein the antenna comprises an active component and a connection to the electrically conductive portion such that the electrically conductive portion serves as a ground plane of the antenna. According to one variation, the housing further comprises a door assembly having a closed position and an open position for allowing user ingress into the internal compartment, the door assembly including a window for allowing viewing of the internal compartment from outside the internal compartment, and the window including the electrically conductive portion in the form of at least one transparent conductive layer. According to another variation, the housing comprises a light fixture for illuminating the internal compartment, wherein the active component of the antenna is disposed in the light fixture. According to yet another variation, the appliance further comprises: a coaxial cable having a center pin and a metal sheath surrounding the metal pin, and a conductive plate electrically coupled to the center pin, wherein the housing further comprises a door frame and a door assembly detachably mounted to the door frame and having a closed position and an open position for allowing user ingress into the internal compartment, wherein the active component of the antenna is disposed at the door assembly, and wherein the conductive plate is mounted to the door frame and is spaced apart but proximate to the door assembly when the door assembly is in the closed position such that the conductive plate is capacitively coupled to the active component of the antenna when the door assembly is in the closed position.

In at least another aspect, an appliance is provided that comprises a housing including an internal compartment; a door assembly having a closed position and an open position for allowing user ingress into the internal compartment; a window provided in the door assembly for allowing viewing of the internal compartment from outside the compartment, the window including at least one transparent conductive layer; and an antenna for at least one of receiving RF signals and transmitting RF signals, wherein the antenna comprises an active component and a connection to the at least one transparent conductive layer such that the at least one transparent conductive layer serves as a ground plane of the antenna.

In at least another aspect, an appliance is provided that comprises a housing including an internal compartment, wherein at least a portion of the housing comprises an electrically conductive portion, wherein the housing comprises a light fixture for illuminating the internal compartment, and an antenna for at least one of receiving RF signals and transmitting RF signals, wherein the antenna comprises an active component and a connection to the electrically conductive portion such that the electrically conductive portion serves as a ground plane of the antenna, wherein the active component of the antenna is disposed in the light fixture.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a perspective view of one embodiment of an appliance with the door assembly in a closed position;

FIG. 2 is an exploded view of a door assembly of the appliance shown in FIG. 1;

FIG. 3 is a partial cross section of the door assembly of the appliance shown in FIG. 1;

FIG. 4 is a perspective view of an oven portion of the appliance shown in FIG. 1 with the door assembly in an open position;

FIG. 5A is a perspective view of an oven portion of the appliance shown in FIG. 1 with an alternate coupling of a coaxial cable to an active component of an antenna disposed at the door assembly;

FIG. 5B is an enlarged view of the alternate coupling shown in FIG. 5A;

FIG. 6 is a side view of the alternate coupling shown in FIGS. 5A and 5B;

FIG. 7 is a perspective view of the internal compartment of the appliance shown in FIG. 1 having a light fixture;

FIG. 8 is a perspective view of the light fixture shown in FIG. 7 with the transparent cover removed;

FIG. 9 is a side view of the light fixture shown in FIG. 7;

FIG. 10 is a perspective view of the light fixture shown from the rear according to one implementation; and

FIG. 11 is a perspective view of the light fixture shown from the rear according to another implementation.

### DETAILED DESCRIPTION OF EMBODIMENTS

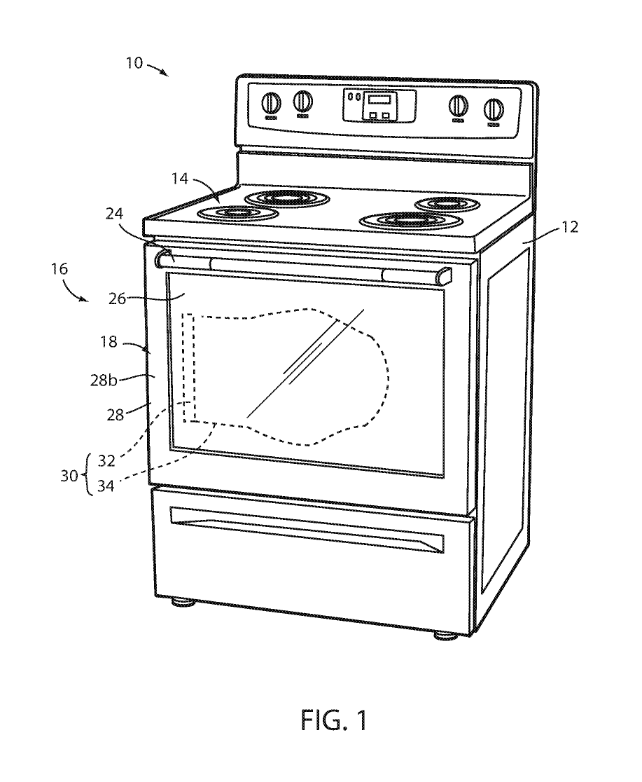

For purposes of description herein, the terms “upper,” “lower,” “right,” “left,” “rear,” “front,” “vertical,” “horizontal,” and derivatives thereof shall relate to the appliance as oriented in FIG. 1. However, it is to be understood that the device may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

It is known in the art of cooking appliances to include a temperature probe that may be inserted into the food being cooked. Such temperature probes may communicate via wireless RF signals to an antenna inside an internal compartment of the appliance. However, the integration of antennas into an appliance cavity can be difficult due to style, cleanability, and damage concerns. The antenna should fit within aesthetic considerations and also must be in a place where it cannot be easily damaged. Moreover, in some instances, it may be desirable to transmit RF signals into and out of the internal compartment of the appliance. However, appliances are predominantly made of metal either as inside cavities or external enclosures. In the case of ovens, both internal and external. Door glass can also be coated with metals (such as tin oxide or silver oxide). This leads to a space that is shielded such that transmission of electromagnetic waves is impossible to cross into/out of the appliance.

Antennas are sensitive to metal surroundings. Metal surroundings can inhibit or disrupt the signal radiation. It is difficult to incorporate an antenna inside an oven cavity due to the metal interior and exterior and the aforementioned style, cleanability, and damage concerns. Where the antenna is a patch antenna, the dielectric substrate used between the patch and the ground plane is sensitive to high temperatures. Such high temperatures can result in signal drop or loss.

Referring to the embodiment illustrated in FIG. 1, reference numeral 10 generally designates an appliance. Appliance 10 may be any type of appliance, but is described herein with respect to a cooking appliance such as a range or wall oven. The particular appliance shown in FIG. 1 is a range having a cooktop 14 and an oven 16.

As shown in FIG. 1, appliance 10 generally includes a housing 12 including an internal compartment 20 and an antenna 30 for at least one of receiving RF signals and transmitting RF signals. Antenna 30 includes an active component 32 and a connection to an electrically conductive portion of housing 12 such that the electrically conductive portion serves as a ground plane 34 of antenna 30.

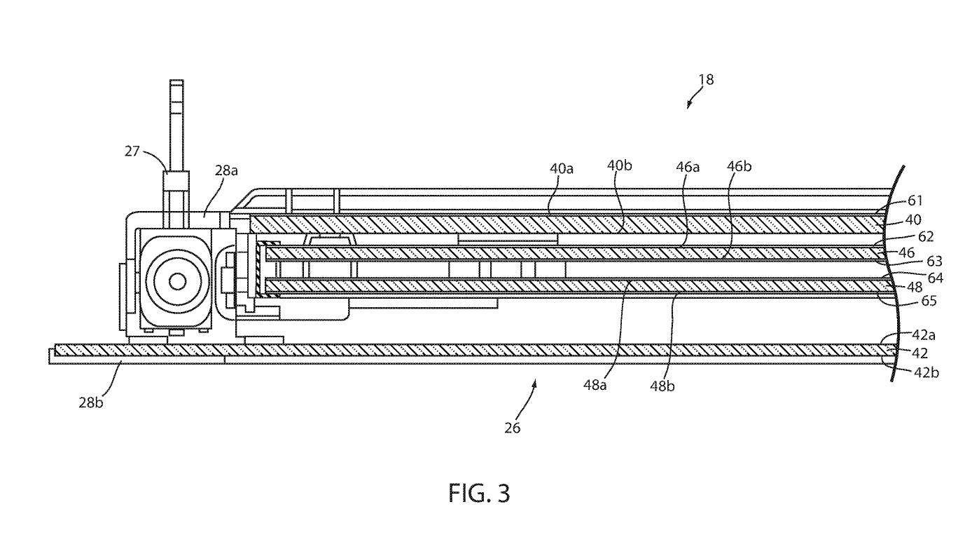

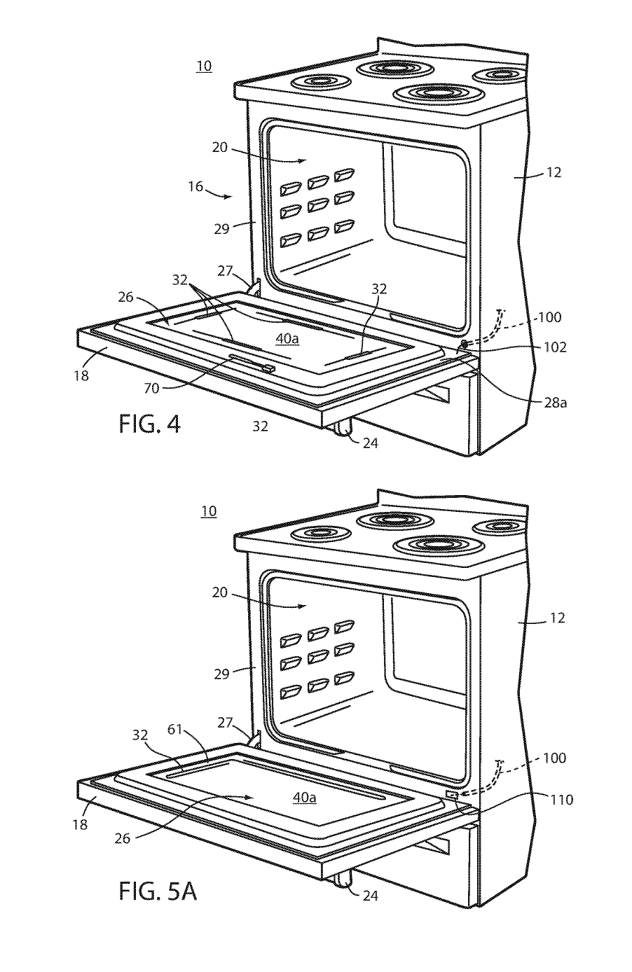

Housing 12 includes a door assembly 18 having a closed position (FIG. 1) and an open position (FIG. 4) for allowing user ingress into internal compartment 20. Door assembly 18 may include a handle 24 and a window 26 for allowing viewing of internal compartment 20 from outside the internal compartment. Window 26 may include the electrically conductive portion in the form of at least one transparent conductive layer 61, 62, 63, 64, 65 (FIG. 3).

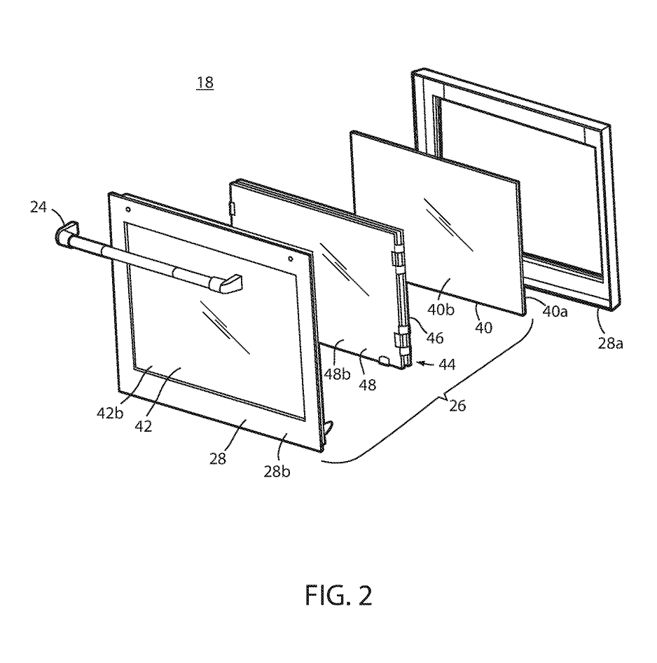

Window 26 may include multiple spaced glass panes. As shown in FIGS. 2 and 3, window 26 includes an interior glass substrate 40 having an interior surface 40a facing internal compartment 20 and an exterior surface 40b, and an exterior glass substrate 42 having an interior surface 42a facing exterior surface 40b of interior glass substrate 40 and an exterior surface 42b that may constitute the outermost surface of window 26. Window 26 may also include an insulated window pack 44 including a first glass sheet 46 and a second glass sheet 48. Insulated window pack 44 is disposed between interior glass substrate 40, and said exterior glass substrate 42 First glass sheet 46 is disposed between second glass sheet 48 and interior glass substrate 40. First glass sheet 46 has an interior surface 46a and an exterior surface 46b. Second glass sheet 48 has an interior surface 48a and an exterior surface 48b. As described further below, the at least one transparent conductive layer 61, 62, 63, 64, 65 is disposed on a surface of at least one of interior glass substrate 40, exterior glass substrate 42, first glass sheet 46 and second glass sheet 48.

A metal skin 28 of door assembly 18 may be disposed around window 26 and have a front side 28a and an interior side 28b. Metal skin 28 may be made of various materials including stainless steel.

As shown in FIG. 3, the at least one transparent conductive layer may be any one of a plurality of such transparent conductive layers. Oven windows often include a number of transparent metal layers used for heat reflection. These layers may be made of tin oxide or silver oxide. Although these layers are not used for their electrical conductivity, the layers can, in fact, conduct electricity and therefore be used as a ground plane 34 for antenna 30. For example, a first transparent conductive layer 61 may be provided on interior surface 40a of interior glass substrate 40. A second transparent conductive layer 62 may be provided on interior surface 46a of first glass sheet 46. A third transparent conductive layer 63 may be provided on exterior surface 46b of first glass sheet 46. A fourth transparent conductive layer 64 may be provided on interior surface 48a of second glass sheet 48. A fifth transparent conductive layer 65 may be provided on exterior surface 48b of second glass sheet 48. Any one or more of these layers can be used as the ground plane 34 of antenna 30. The particular transparent conductive layer used as the ground plane 34 may depend on the configuration and location of the active component 32 of antenna 30. Various possible implementations are described below.

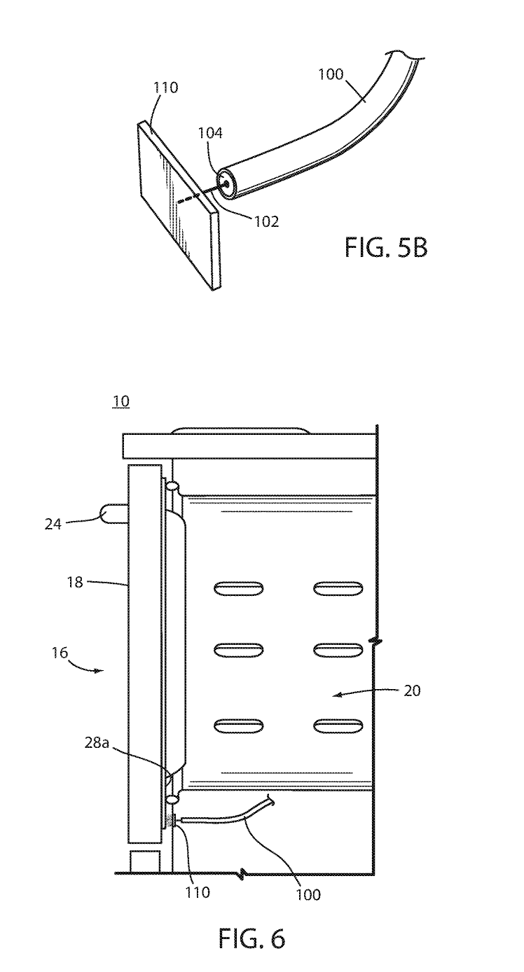

According to a first implementation, the at least one transparent conductive layer is first transparent conductive layer 61 disposed on interior surface 40a of interior glass substrate 40. Thus, first transparent conductive layer 61 serves as ground plane 34 of antenna 30. Active component 32 of antenna 30 includes a thin conductive substance (such as metallic ink, wire, etc.) printed on interior surface 40a of interior glass substrate 40. As shown in FIGS. 4 and 5A, the printed thin conductive substance serving as active component 32 may extend along a perimeter of window 26 while being physically separated from ground plane 34 (FIG. 3). In this implementation the antenna would transmit and/or receive signals from within internal compartment 20. Multiple printed thin conductive tracings may be disposed about the perimeter of window 26 to form multiple antennas if desired. The antenna(s) may be monopole or dipole. Note that in FIG. 4, active components 32 would be used in place of metal conductor 70 (described below).

If it is desired to provide exterior signal coverage, active component 32 may be printed on the interior surface 42a of exterior glass substrate 42 and the at least one transparent conductive layer is fifth transparent conductive layer 65 disposed on exterior surface 48b of second glass sheet 48 such that fifth transparent conductive layer 65 serves as ground plane 34.

As shown in FIG. 4, electrical connection to active component 32 and ground plane 34 of antenna 30 may be made using a coaxial cable 100 having a center pin 102 and a metal sheath 104 that is insulated from center pin 102 and surrounds the center pin. Metal sheath 104 may be electrically coupled to transparent conductive layer 61, 62, 63, 64, 65 (serving as ground plane 34) and center pin 102 may be electrically coupled to said active component 32. Coaxial cable 100 may be run through the hinge that connects door assembly 18 to appliance 10. Another technique for making the coaxial connection is described below with respect to FIGS. 5A and 5B.

According to another implementation, interior side 28a of metal skin 28 (which may be stainless steel) surrounding window 26 of door assembly 18 is electrically coupled to center pin 102 such that interior side 28a of metal skin 28 acts as active component 32 of antenna 30. In this implementation, the at least one transparent conductive layer 61, 62, 63, 64, 65 is first transparent conductive layer 61 disposed on interior surface 40a of interior glass substrate 40 such that first transparent conductive layer 61 serves as ground plane 34. In this arrangement the antenna 30 communicates with one or more devices within the internal compartment 20. To communicate with external devices, the exterior side 28b of metal skin 28 may be used as the active component 32 while the at least one transparent conductive layer 61, 62, 63, 64, 65 is fifth transparent conductive layer 65 disposed on exterior surface 48b of second glass sheet 48 such that fifth transparent conductive layer 65 serves as ground plane 34.

According to another implementation shown in FIG. 4, a physical antenna 30 may be mounted on door assembly 18. More specifically, a separate metal conductor 70 may be mounted on door assembly 18 to serve as active component 32 while at least one transparent layer 61, 62, 63, 64, 65 in window 26 is used as ground plane 34. For interior signal coverage, separate metal conductor 70 may be mounted on the inside door frame of door assembly 18 and the at least one transparent conductive layer 61, 62, 63, 64, 65 is first transparent conductive layer 61 disposed on interior surface 40a of interior glass substrate 40 such that first transparent conductive layer 61 serves as ground plane 34. For exterior signal coverage, separate metal conductor 70 may be mounted on the outside of door assembly 18 and the at least one transparent conductive layer 61, 62, 63, 64, 65 is fifth transparent conductive layer 65 disposed on exterior surface 48b of second glass sheet 48 such that fifth transparent conductive layer 65 serves as ground plane 34. One location for the mounting of separate metal conductor 70 on the outside of door assembly 18 is to provide metal conductor 70 in handle 24. Note that metal conductor 70 would be used in place of active components 32 shown in FIG. 4.

In another implementation, a patch antenna may be used for antenna 30. In this case, active component 32 may comprise one of the transparent conductive layers in window 26 while another one of the transparent conductive layers serves as ground plane 34 and air and/or glass is the dielectric layer between active component 32 and ground plane 34. For example, for interior signal coverage, the active component patch 32 may be the first transparent conductive layer 61 disposed on interior surface 40a of interior glass substrate 40 while ground plane 34 may be the first transparent conductive layer 61 disposed on interior surface 46a of first glass sheet 46 as shown in FIG. 3. For exterior signal coverage, the active component patch 32 may be the fifth transparent conductive layer 65 disposed on exterior surface 48b of second glass sheet 48 while ground plane 34 may be the fourth transparent conductive layer 64 disposed on interior surface 48a of second glass sheet 48. It should be noted that the two patch antennas may be combined to provide coverage both inside and outside the appliance.

As shown above with respect to FIG. 4, connections to antenna 30 may be made directly (or indirectly) via coaxial cable 100. One way of indirectly coupling antenna 30 to coaxial cable 100 is shown in FIGS. 5A, 5B, and 6 where capacitive coupling is used such that coaxial cable 100 does not need to physically connect to door assembly 18. This provides the benefit that the door assembly 18 may be more easily detached from appliance 10. This can provide a significant advantage in appliances that require detachment of the door assembly due to installation of trim built into the appliance. In this case, a conductive plate 110 is electrically coupled to center pin 102 of coaxial cable 100. Housing 12 may further include a front door frame 29 and door assembly 18 may be detachably mounted to front door frame 29 and having a closed position and an open position for allowing user ingress into internal compartment 20. Conductive plate 110 is mounted to door frame 29 and is spaced apart but proximate to door assembly 18 when door assembly 18 is in the closed position such that conductive plate 110 is capacitively coupled to active component 32 of antenna 30 when door assembly 18 is in the closed position. When the active component 32 is the interior side 28a of metal skin 28, the capacitive coupling may be directly between conductive plate 110 and metal skin 28. Alternatively, a second conductive plate may be mounted to the inside of the door assembly 18 opposite conductive plate 110 with the second conductive plate electrically connected to active component 32 via wires or other coaxial cable. If the first transparent conductive layer 61 is acting as the active component 32 of a patch antenna as described above, the conductive plate 110 may be positioned to be opposite first transparent conductive layer 61 so as to be directly capacitively coupled thereto. The connection to ground plane 34 may also be made via the door hinge(s) 27, which may serve as a ground conductor.

As discussed above, there is also the possibility of having multiple antennas mounted to the door assembly 18 as well as multiple conductive plates capacitively coupling the antennas to respective coaxial cables. Providing multiple antennas 30 can help with signal strength and omnidirectionality inside of the internal compartment 20 or to allow communications both inside and outside the appliance.

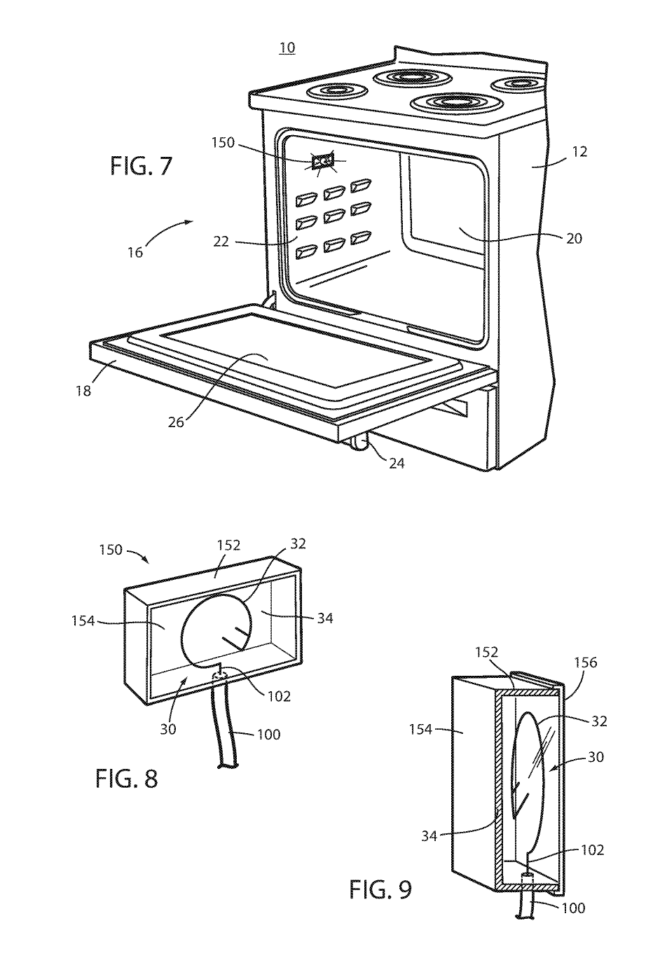

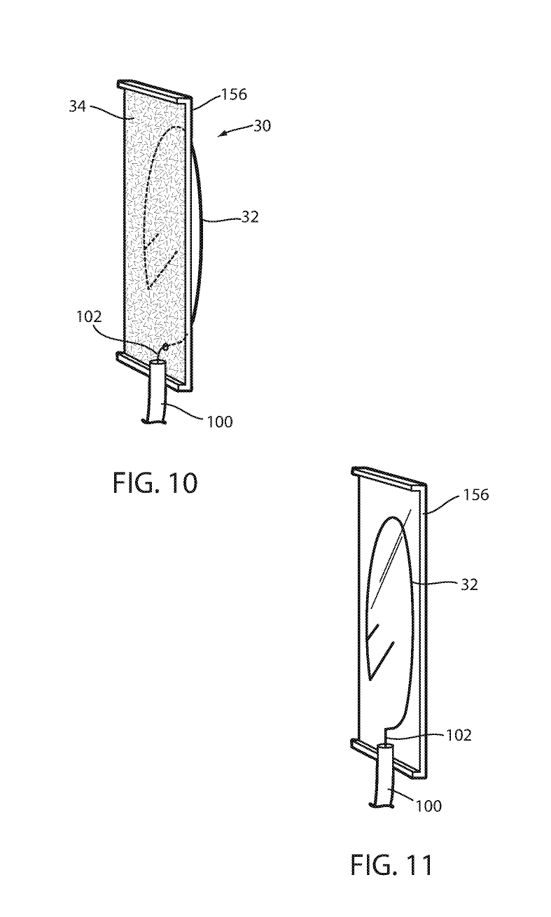

As shown in FIGS. 7-10, housing 12 may further include a light fixture 150 positioned on an interior wall 22 of internal compartment 20 for illuminating internal compartment 20. As an alternate location for antenna 30 or as a location for an additional antenna to one disposed in door assembly 18, one could provide the antenna 30 in light fixture 150. Specifically, active component 32 of antenna 30 may be disposed in light fixture 150. This location would serve primarily for communication with a device placed inside internal compartment 20. If communication was also desired outside the appliance, an antenna could be disposed elsewhere including the door assembly 18 as described above.

Light fixture 150 may include the electrically conductive portion constituting ground plane 34 of antenna 30. Alternatively, a portion or all of interior wall 22 of housing 12 may include the electrically conductive portion constituting ground plane 34. Light fixture 150 includes an enclosure 152 having at least one metal wall 154, which may serve as ground plane 34. Light fixture 150 includes a transparent cover 156, which may be made of glass, through which light from a light source is transmitted into internal compartment 20. Active component 32 of antenna 30 may be disposed on either surface of transparent cover 156. As shown, the active component 32 may be a circular F antenna. Transparent cover 156 is preferably made of glass, which transmits light and does not inhibit radio waves.

In one implementation, active component 32 is disposed on the surface of transparent cover 156 that faces internal compartment 20. In this case, a transparent conductive coating may be provided on the opposite surface of cover 156 to serve as ground plane 34. Accordingly, metal sheath 104 of coaxial cable 100 is coupled to the transparent conductive coating serving as ground plane 34 and center pin 102 is connected to active component 32, which may be in the form of a wire or printed conductive material.

In another implementation, active component 32 is disposed on the surface of transparent cover 156 opposite the one that faces internal compartment 20. In this case, at least one metal wall 154 of enclosure 152 may serve as ground plane 34. Accordingly, metal sheath 104 of coaxial cable 100 is coupled to metal wall 154 and center pin 102 is connected directly to active component 32 through a hold in the back of enclosure 152 of light fixture 150.

Although the above embodiments are described as having the active component 32 of the antenna 30 provided in door assembly 18 and/or light fixture 150, the active component 32 may be disposed in any other component within internal compartment 20 while a portion of housing 12 may be used as the ground plane 34.

By having the active component 32 of the antenna 30 provided in door assembly 18, light fixture 150, or other component while a portion of housing 12 is used as the ground plane 34, an antenna 30 may be integrated in an appliance in such as way that it does not impact the style or cleanability of the appliance and without raising any damage concerns. Moreover, antennas can be integrated so as to transmit and receive signals into and out of the internal compartment of the appliance. Further, antennas can be integrated into the appliance while using some of the existing structure as a ground plane and/or active component of the antenna and thereby reduce construction time and expense.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms—couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. An appliance comprising:
a housing including an internal compartment, wherein at least a portion of the housing comprises an electrically conductive portion; and
an antenna for at least one of receiving RF signals and transmitting RF signals, wherein the antenna comprises an active component and a connection to said electrically conductive portion such that said electrically conductive portion serves as a ground plane of said antenna.

2. The appliance of claim 1, wherein said housing further comprises a door assembly having a closed position and an open position for allowing user ingress into said internal compartment, said door assembly including a window for allowing viewing of the internal compartment from outside the internal compartment, said window including said electrically conductive portion in the form of at least one transparent conductive layer.

3. The appliance of claim 1, wherein said housing comprises a light fixture for illuminating said internal compartment, wherein said active component of said antenna is disposed in said light fixture.

4. The appliance of claim 1 and further comprising:
a coaxial cable having a center pin and a metal sheath surrounding the center pin; and
a conductive plate electrically coupled to said center pin;
wherein said housing further comprises a door frame and a door assembly detachably mounted to said door frame and having a closed position and an open position for allowing user ingress into said internal compartment,
wherein said active component of said antenna is disposed at said door assembly, and
wherein said conductive plate is mounted to said door frame and is spaced apart but proximate to said door assembly when said door assembly is in the closed position such that said conductive plate is capacitively coupled to said active component of said antenna when said door assembly is in the closed position.

5. The appliance of claim 4, wherein said door assembly includes a metal skin that is capacitively coupled to said conductive plate when said door assembly is in the closed position, and wherein said metal skin serves as an active component of said antenna.

6. The appliance of claim 4, wherein said door assembly includes a window for allowing viewing of the internal compartment from outside the internal compartment, said window including a glass substrate having an interior surface, wherein said antenna is a patch antenna and said active component of said antenna comprises a transparent metallic layer disposed on said interior surface of said glass substrate, and wherein said transparent metallic layer is capacitively coupled to said conductive plate when said door assembly is in the closed position.

7. The appliance of claim 1, wherein said appliance is an oven.

8. An appliance comprising:
a housing including an internal compartment;
a door assembly having a closed position and an open position for allowing user ingress into said internal compartment;
a window provided in said door assembly for allowing viewing of the internal compartment from outside the compartment, said window including at least one transparent conductive layer; and
an antenna for at least one of receiving RF signals and transmitting RF signals, wherein said antenna comprises an active component and a connection to said at least one transparent conductive layer such that said at least one transparent conductive layer serves as a ground plane of said antenna.

9. The appliance of claim 8, wherein said at least one transparent conductive layer is a layer of tin oxide.

10. The appliance of claim 8, wherein said window comprises:
an interior glass substrate having an interior surface facing said internal compartment and an exterior surface;
an exterior glass substrate having an interior surface facing said exterior surface of said interior glass substrate and an exterior surface; and
an insulated window pack comprising a first glass sheet and a second glass sheet disposed between said interior glass substrate and said exterior glass substrate, said first glass sheet disposed between said second glass sheet and said interior glass substrate, said first glass sheet having an interior surface and an exterior surface, said second glass sheet having an interior surface and an exterior surface,
wherein said at least one transparent conductive layer is disposed on a surface of one of said interior glass substrate, said exterior glass substrate, said first glass sheet and said second glass sheet.

11. The appliance of claim 10 and further comprising a coaxial cable having a center pin and a metal sheath surrounding the center pin for electrically coupling to said antenna, wherein said metal sheath is electrically coupled to said at least one transparent conductive layer, said door assembly includes a metal skin surrounding said window on said door assembly, and wherein said center pin is connected to said metal skin such that said metal skin acts as said active component of said antenna.

12. The appliance of claim 10, wherein said active component of said antenna comprises a separate metal conductor mounted to said door assembly.

13. The appliance of claim 10, wherein said active component of said antenna comprises a thin conductive substance printed on one of said interior surface of said exterior glass substrate and said interior surface of said interior glass substrate.

14. The appliance of claim 10, wherein said antenna is a patch antenna and said active component of said antenna comprises a transparent conductive layer disposed on said interior surface of said interior glass substrate.

15. The appliance of claim 8 and further comprising:
a coaxial cable having a center pin and a metal sheath surrounding the metal pin; and
a conductive plate electrically coupled to said center pin;
wherein said housing further comprises a door frame, said door assembly detachably mounted to said door frame,
wherein said active component of said antenna is disposed at said door assembly, and
wherein said conductive plate is mounted to said door frame and is spaced apart but proximate to said door assembly when said door assembly is in the closed position such that said conductive plate is capacitively coupled to said active component of said antenna when said door assembly is in the closed position.

16. An appliance comprising:
a housing including an internal compartment, wherein at least a portion of the housing comprises an electrically conductive portion, wherein said housing comprises a light fixture for illuminating said internal compartment; and
an antenna for at least one of receiving RF signals and transmitting RF signals, wherein the antenna comprises an active component and a connection to said electrically conductive portion such that said electrically conductive portion serves as a ground plane of said antenna,
wherein said active component of said antenna is disposed in said light fixture.

17. The appliance of claim 16, wherein said light fixture comprises an enclosure having at least one metal wall comprising said electrically conductive portion, wherein said at least one metal wall serves as said ground plane of said antenna.

18. The appliance of claim 16, wherein said light fixture includes a transparent cover and wherein said active component of said antenna is disposed on a surface of said transparent cover.

19. The appliance of claim 18, wherein said active component of said antenna is disposed on a surface of said transparent cover that faces said internal compartment, wherein said transparent cover includes a transparent conductive coating on an opposite surface, and wherein said electrically conductive portion is said transparent conductive coating such that said transparent conductive coating constitutes said ground plane of said antenna.

20. The appliance of claim 16, wherein said housing further comprises an interior wall defining a portion of said internal compartment, wherein said light fixture is mounted to said interior wall, and wherein said interior wall comprises said electrically conductive portion constituting said ground plane of said antenna.
